(19) United States
(12) Patent Application Publication
(10) Pub. No.: US 2013/0002078 A1
(43) Pub. Date: Jan. 3, 2013

(54) ROTOR OF A MULTIPOLAR SYNCHRONOUS ELECTRIC MACHINE WITH SALIENT POLES

(75) Inventors: Brahim Ammar, Louvres (FR); Patrick Letourneur, Coulsore (FR)

(73) Assignee: JEUMONT ELECTRIC, Jeumont (FR)

(21) Appl. No.: 13/535,988

(22) Filed: Jun. 28, 2012

(30) Foreign Application Priority Data
Jun. 29, 2011 (FR) 1155840

(51) Int. Cl. H02K 1/17

(52) U.S. Cl. 310/156.07

(57) ABSTRACT

A rotor of a multipolar synchronous electric machine, with salient poles, includes a plurality of salient poles and a source of magnetomotive force, distributed on each of the salient poles, configured to generate a magnetic flux configured to encompass the armature of a stator, a part of the magnetic flux generated by the source of magnetomotive force, designated leakage flux, being dispersed between the salient poles of the rotor; the rotor including a magnetic compensation source configured to compensate the leakages of magnetic flux dispersed between the salient poles, the compensation source being dimensioned so as to compensate at least a part of the leakage flux.

This application is based upon and claims the benefit of priority from French Patent Application No. 1155840, filed Jun. 29, 2011, the entire content of which is incorporated herein by reference.

The present invention concerns the field of synchronous electric rotating machines having high electrical performance, comprising a stator assembly and a rotor assembly, the rotor assembly pivoting with respect to the stator assembly about a rotation axis.

More particularly, the present invention concerns a rotor of a multipolar synchronous electric machine of heteropolar type, comprising a plurality of salient poles and of pole shoes.

Generally, the salient pole rotors have field poles situated on the periphery of a ring of the magnetic circuit.

These rotors are generally used in slow speed applications up to 1200 r/min with laminated poles and 1800 r/min with solid poles.

In a known manner, the rotor of a synchronous electric machine with salient poles includes:
a central part formed by the ring of the magnetic circuit and by a central shaft; for rotors which have a small diameter, the central shaft and the ring of the magnetic circuit form only one single piece;
salient poles or poles formed by a central part, designated pole body or else polar body, and by a peripheral part designated pole shoe; each pole is passed through, in its central part, by a constant magnetic flux; on the other hand, at the surface of the pole at the level of a pole shoe, the induction is pulsed as a result of the rotation in front of the slots of the stator;
induction coils surrounding each polar body, formed by a stack of windings.

The synchronous machines are electric machines, the rotation speed of the output shaft of which is equal to the rotation speed of the magnetic field. The magnetisation of the rotating machines with salient poles is obtained by the inductor formed by the induction coils surrounding the polar bodies.

The total field flux φₜ of the rotating machine is composed conventionally of a useful component (useful flux φᵤ) encompassed by the armature (i.e. the stator) and of a dispersion component, designated leakage flux φ_{f}. These magnetic leakages present in the rotating machines are highly dependent on the geometry of the machine, and in particular on the interpolar space and the number of poles of the rotor.

In order to reduce these magnetic leakage fluxes between the magnetic poles of the rotor, it is known:
either to increase the space between two poles; in this case, the volume and the weight of the electric rotating machine are increased, which poses problems of overall dimensions in certain fields of use, such as for example in the maritime field or else in the field of wind energy;
or to reduce the ampere-turns, the leakages at the level of the rotor being proportional thereto, which means a decommissioning of the machine and hence a considerable increase in costs.

The existing solutions aiming to limit the magnetic leakages between the magnetic poles at the level of the rotor do not bring entire satisfaction and are not viable solutions with respect to the current requirements, such as the requirements concerning overall dimension, reduction in costs and increase of the output of the rotating electric machines.

In this context, an aspect of the invention aims to provide a rotor for a rotating electric machine with salient poles, configured to improve the performances of the rotating electric machines by reduction of the impact of the flux of magnetic leakages between the salient poles of the rotor, while meeting the current requirements for compactness and output.

To this end, there is provided in an embodiment of the invention a rotor of a multipolar synchronous electric machine including a plurality of salient poles and a source of magnetomotive force, distributed on each of the salient poles, configured to generate a magnetic flux φ suited to encompass the armature of a stator, one part φ_{f} of the magnetic flux generated by the magnetomotive force, designated the leakage flux, being dispersed between the salient poles of the rotor; the rotor including a magnetic compensation source configured to compensate the leakages of magnetic flux φ_{f} dispersed between the salient poles, the compensation source being dimensioned so as to compensate at least one part of the said leakage flux.

“Configured to compensate the leakages of magnetic flux” is understood to mean the establishing of a magnetic equilibrium, whether total or partial, by the generation of a complementary magnetic flux contrary to the direction of the leakages of magnetic flux, the complementary magnetic flux, designated for compensation, aiming to make up for at least a portion of the magnetic leakages of the rotating machine.

The use of a magnetic compensation source permits given operating conditions beneficially to limit the phenomenon of magnetic saturation at the base of the polar bodies by the suppression of at least a portion of the leakage flux participating, with the principal magnetic flux, in the saturation of the rotor at the level of the base of the polar bodies. Thus, the use of a compensation source according to an embodiment of the invention permits the power to be optimized without modifying the dimensions of the rotor by the increase of the principal magnetic flux up to permissible magnetic saturation.

An embodiment of the invention thus permits the optimization of the output, the power provided by a rotating machine by the total or partial compensation of the leakages of magnetic flux which are present intrinsically in a rotating machine.

Due to an embodiment of the invention, it is possible to produce rotating machines with a higher performance without increasing their overall dimensions, which meets the current tendencies for compactness and increase of output.

An embodiment of the invention is to be differentiated from homopolar or pseudo-homopolar synchronous machines, the architecture and the demands for use of which are very different from the synchronous machines with salient poles. In fact, such machines include a single excitation coil around an integral axial core of two discs including a succession of teeth and slots over its external periphery.

The rotor of the multipolar synchronous electric machine, with salient poles, according to an embodiment of the invention can also present one or more of the characteristics below, considered individually or according to all the technically possible combinations:
the magnetic compensation source includes a permanent magnet;
each salient pole of the plurality includes a pair of pole tips situated on either side of the salient pole, the magnetic compensation source being mounted detachably between two pole tips at the level of an inter-polar space;
the pole tips include a groove, the shape of which it adapted to receive the compensation source by sliding;
the grooves are continuous along the pole tips;
the shape of the grooves and the complementary shape of the compensation source are adapted to keep the compensation source radially under the effect of the centrifugal force;
the magnetic compensation source is formed by a compensation block including at least one permanent magnet, the compensation block being positioned between two salient poles;
the compensation block is formed by two non-magnetic plates arranged on either side of the at least one permanent magnet;
the compensation block includes two shims of mild steel bordering the at least one magnet, the shape of the shims being configured to cooperate with the grooves of the pole tips;
the magnetic compensation source includes an electromagnet;
the magnetic compensation source includes an induction coil;
the magnetic compensation source includes at least one duct configured to permit the circulation of a cooling fluid;
the source of magnetomotive force is realized by induction coils surrounding each salient pole;
the source of magnetomotive force is realized by permanent magnets;
the rotor includes a first source of magnetomotive force realized by induction coils and a second source of magnetomotive force realized by permanent magnets.

An aspect of the invention relates to a synchronous electric machine including a rotor with salient poles.

Other characteristics and benefits of various embodiments of the invention will emerge more clearly from the description which is given thereof below, by way of indication and in no way restrictive, with reference to the attached figures, in which:

FIG. 1 is a partial view, in perspective, of a rotor with salient poles of a synchronous electric machine according to an embodiment of the invention;

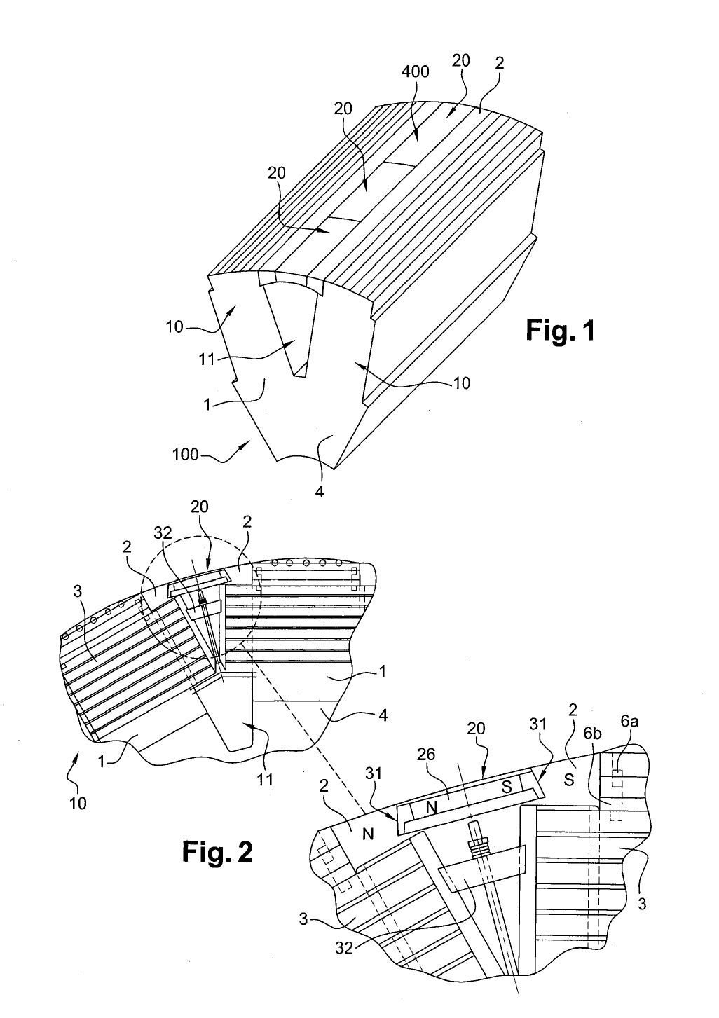

FIG. 2 is a partial view, in section through a plane perpendicular to the rotation axis of the rotor, of a rotor with salient poles according to an embodiment of the invention;

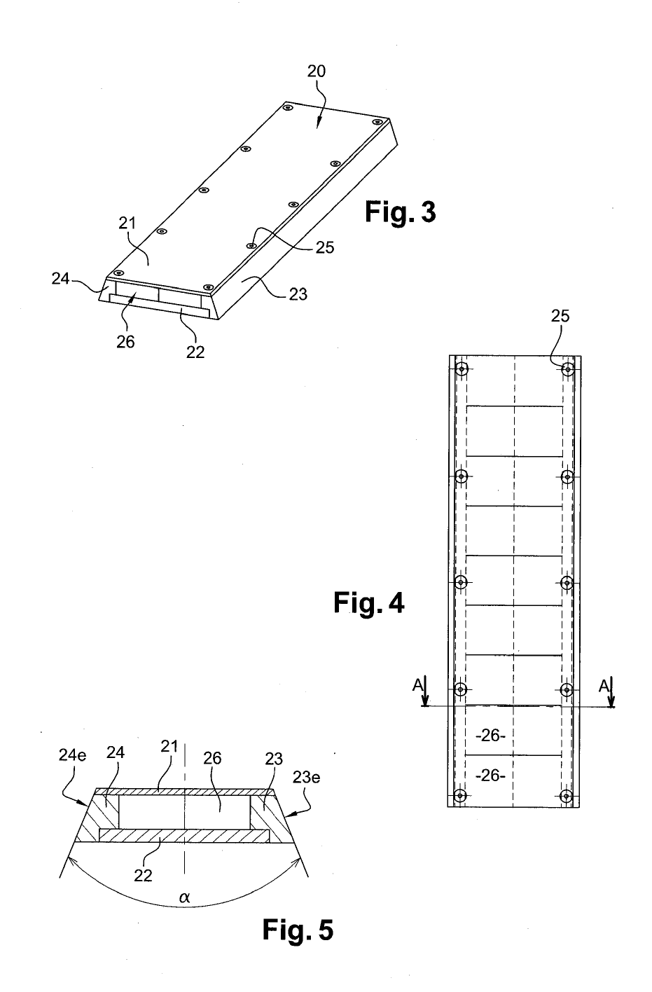

FIG. 3 is a perspective view of an example of a magnetic compensation source of the rotor with salient poles of a synchronous electric machine illustrated in FIG. 1;

FIG. 4 is a top view of the magnetic compensation source illustrated in FIG. 3;

FIG. 5 is a view in section of the magnetic compensation source illustrated in FIGS. 3 and 4 according to a section plane AA illustrated in FIG. 4.

In all the figures, the common elements bear the same reference numbers, unless specified otherwise.

FIG. 1 represents a partial view, in perspective, of a rotor 100 with salient poles of a synchronous electric machine according to an embodiment of the invention.

FIG. 1 represents more particularly a portion of the rotor 100 presenting a space 11, designated the interpolar space, situated between two salient poles 10, with FIG. 1 only representing a portion of the salient poles 10.

Each salient pole 10 of the rotor 100 is formed by a pole body 1, also designated polar body, surrounded by an induction coil 3 (FIG. 2); for better legibility of FIG. 1, the induction coil 3 surrounding each polar body 1 is not represented in FIG. 1.

According to the illustrated embodiment, the polar body 1 is a piece forming an integrating part of a rim 4 constituting the polar wheel of the magnetic circuit of the synchronous electric machine. In an embodiment, the rim 4 is realized by a stack of sheets of magnetic steel mounted hot on a shaft or a hub (not shown). According to another embodiment, the polar body 1 is a solid monoblock piece forming an integrating part of the shaft.

According to another embodiment of the invention, the polar body is a solid piece, or a laminated piece, added and integrated on the rim 4, or on the shaft, by conventional fixing devices or fasteners, such as a screwing device, keys or dovetail joints.

The induction coil 3 is realized by a copper conductor of circular or rectangular section surrounding the polar body 1 with a certain number of windings. The induction coils 3 of the rotor 100 form the inductor of the rotor and constitute a source of magnetomotive force configured to generate a magnetic flux φ.

Pole tips 2 are situated, in pairs, on either side of a polar body 1 and extend over the entire length thereof, a single pole horn 2 of the said pair being represented on each polar body 1.

The pairs of pole tips 2 keep the induction coil 3 in position on either side of the polar body.

The pole tips are also an integrating part of the pole shoe and thus permit the spreading of the magnetic flux at the level of the interferric space, and their profile is designed to obtain an interferric space induction wave close to sinusoidal so as to minimize the spatial harmonics.

Keeping the induction coil 3 tangential, on rotation of the rotor, is also realized conventionally for keying wedges 32 positioned in the interpolar space 11.

According to an embodiment of the invention, the pole tips 2 comprise fastening 6b configured to cooperate with slots 6a arranged on either side of the polar body 1 and extending over the length of the polar body 1, thus forming ducts on either side of the polar body 1.

The fastening 6b permit the placement of the pole tips 2 by fitting and/or by sliding in the slots 6a of the polar bodies 1 without other fixing device. The fitting is carried out from each end of the polar body 1, and the sliding following the longitudinal direction of the said polar body 1. The fastening 6b have the shape, for example, of a hook.

Thus, the particular shape of the fastening 6b permits a radial holding of the pole tips 2, and permits the enclosing of the stresses caused by the centrifugal force of the induction coil 3 on the rotation of the rotor, and in particular of the radial component.

According to another embodiment of the invention, the pole tips form integrating parts of a pole shoe added and integrated on the polar body by conventional integrating means, such as screwing means. The pole shoe is positioned on the polar body when the induction coil is put in place around the polar body.

According to another embodiment of the invention, the pole tips are integrated to the shoe, which itself is integrated to the polar body, the induction coil being put in place around the polar body and clamped radially between the internal faces of the pole tips and clamps screwed in housings formed on the periphery of the internal face of the polar body. The coiled pole assembly is mounted by screwing or keying on the rim.

The rotor 100 according to an embodiment of the invention further comprises a magnetic compensation source 400 configured to generate a complementary magnetomotive force (fmm) intended to compensate at least partially the magnetic leakage fluxes φ_{f} generated intrinsically in the rotating machine on the generation of the magnetic flux φ by the induction coils 3.

According to an embodiment of the invention, the magnetic compensation source includes at least one electromagnet.

According to an embodiment of the invention, the magnetic compensation source includes at least one complementary field winding, the complementary field winding being different from the field windings formed by the induction coils surrounding the polar bodies.

According to an embodiment of the invention, the magnetic compensation source includes at least one permanent magnet 26.

According to this latter embodiment, illustrated in the figures, this compensation source 400 is formed by a plurality of compensation blocks 20 integrating a plurality of permanent magnets 26, the compensation blocks being positioned at the level of the interpolar space 11 of the rotor 100.

To this end, the pole tips 2 comprise at the level of their end, facing towards the interpolar space 11, grooves 31 configured to cooperate with the compensation blocks 20. The shape of the grooves 31 is determined as a function of the shape of the compensation blocks 20. For example, the shape of the grooves 31 can be determined so as to be able to receive, by sliding, the compensation blocks 20 between two pole tips 2 when the rotor is already assembled.

The shape of the grooves 31 is also determined so as to ensure the maintaining of the compensation blocks 20 during the rotation of the rotor 100.

The detail of FIG. 2 illustrates in particular the assembly of a compensation block 20 between to pole tips 2 including such a groove 31.

According to the embodiment illustrated in FIG. 1, the compensation source 400 is formed by three compensation blocks 20, such a block 20 is illustrated in particular in detail in FIGS. 3, 4 and 5.

According to another embodiment of the invention, the compensation source 400 is formed by a single compensation block extending over the entire length of the rotor. However, the use of several compensation blocks 20 allows the handling and also the mounting/dismantling of the compensation source to be facilitated.

The blocks disposed between the pole tips and introduced according to the axial direction of the rotor can be positioned closely or in clear view so as to realize a radial ventilation.

The use of several compensation blocks also permits the facilitating of the mounting/dismantling of the compensation source 400 when the electric machine is already mounted (i.e. when the rotor is assembled in the stator).

As illustrated in FIGS. 3, 4 and 5, the compensation block 20 is formed by:
a lower non-magnetic plate 22:
an upper non-magnetic plate 21;
two lateral shims 23 and 24 of mild steel,
and permanent magnets 26 positioned sandwiched between the two non-magnetic plates 21 and 22.

The non-magnetic plates 21 and 22 and the lateral shims 23, 24 are integrated by screwing device 25. According to another embodiment, the non-magnetic plates 21 and 22 and the lateral shims 23, 24 are integrated by riveting or else by gluing.

Beneficially, the permanent magnets 26 are standardized basic blocks of current dimensions. The use of such basic blocks thus allows the production costs of the compensation source 400 to be reduced.

The permanent magnets 26 are positioned between the two non-magnetic plates 21 and 22, respecting the polarities of the rotors. An example of positioning of the permanent magnets 26 as a function of the polarity of the rotors is represented in the detail of FIG. 2.

The magnets 26 are beneficially glued on the non-magnetic plates 21, 22.

The dimension of the permanent magnets 26, and more particularly the thickness of the magnets 26, is adapted as a function of the degree of compensation of the leakages of desired magnetic flux. Thus, it is possible to compensate entirely or only partially the leakages of magnetic flux at the level of the rotor, as a function of wishes and needs.

The shims 23, 24 of mild steel, bordering the compensation block 20 laterally, present respectively an external face 23e, 24e, the geometry of which is adapted to come to fit by sliding in the grooves 31 which are arranged in the peripheral part of the pole tips 2. The external faces 23e, 24e present an oblique profile with respect to the radial axis of the rotor 100 and thus form an opening angle α.

Beneficially, the opening angle α formed by the external faces of the two shims is determined so as to ensure the maintaining in position of the compensation blocks 20 between the pole tips 2 on the rotation of the rotor 100. The opening angle α is also dependent on the number of salient poles 10 on the rotor.

By way of example, the opening angle α illustrated in the figures for a rotor comprising 12 salient poles is in the order of 30°.

The use of the shims 23, 24 of mild steel further permits the pole tip 2 to be extended, with the shim 23, 24 then taking part in the function of the pole tips, an integrating part of the pole shoe, i.e. the improvement of the induction wave shape in the interferric space so as to minimize the induction harmonic ratio.

The embodiment which has just been described permits a rapid mounting and/or a dismantling of the compensation source 400 by sliding between the pole tips 2 at the level of the interpolar space 11. The mounting and dismantling operations of the compensation source 400 are therefore possible on a mounted rotor or else on a mounted electric machine (i.e. the rotor introduced in the stator). This latter possibility further allows the problem to be overcome of the mounting of a rotor equipped with permanent magnets in the interior of a stator.

According to another simplified embodiment of the invention (not illustrated), the compensation source is formed by permanent magnets 26 integrated on a non-magnetic support plate. The assembly which is thus constituted can be inserted by sliding in grooves provided for this purpose in the pole tips as described previously.

The manner of mounting by sliding of the compensation source 400 also has the benefit of improving the maintenance on site. In fact, if it were necessary to dismantle the rotor for maintenance, the compensation source would then be dismantled first, so as to facilitate the removal of the rotor and, of course, its re-mounting.

The compensation source 400 is dimensioned such that the rotating machine can still function, in a more or less degraded manner, without the presence of this compensation source in place on the rotor.

According to another embodiment of the invention, the compensation source 400 can comprise orifices or ducts suited to permit a circulation of a cooling fluid. Thus, on the rotation of the rotor 100, the ambient air or the surrounding cooling fluid enters into the interpolar space 11, to re-emerge at the level of the orifices or of the ducts arranged at the level of the compensation source. It is also possible to arrange a fan at the inlet of this space 11 so as to create a circulation flux of the cooling fluid or to increase the natural circulation flux created by the rotation of the rotor 100.

According to a first example embodiment, the compensation blocks can include traversing orifices, distributed over the length of the rotor. These orifices thus permit the circulation of a cooling fluid in a radial manner, from the interpolar space 11 towards the exterior of the rotor 100 (i.e. towards the interferric space and the stator of the rotating machine), thus improving the cooling of the induction coils and the stator windings.

According to a second example embodiment, ducts or orifices can be arranged at the level of the junction of the different compensation blocks, for example by the creation of a space between two compensation blocks or else by the realization of a slot at the level of the longitudinal ends of the compensation blocks.

Thus, in an embodiment of the invention there is provided a multipolar rotor, with salient poles, of a synchronous electric machine permitting for example an improvement of the output of the rotating machine without modification of its volume, or else an improvement of the power supplied with respect to a conventional rotating machine (with an identical current density of the rotor and a density of flux).

Finally, the rotor with salient poles according to an embodiment of the invention permits a simple and rapid mounting, without special tools, of the complementary compensation source. The ingenious form of the pole tips and of the compensation source permits both a rapid and easy mounting and, at the same time, a maintaining of the induction coil during stoppage and during the rotation of the rotor.

In addition, the rotor with salient poles according to an embodiment of the invention can also function at degraded conditions in the case of the absence of the compensation source.

A multipolar rotor with salient poles of a synchronous electric machine, comprising induction coils as source of magnetomotive force has been essentially described; however, embodiments of the invention are also applicable to a multipolar rotor with salient poles of a synchronous electric machine including a source of magnetomotive force formed by permanent magnets or else to a synchronous electric machine comprising two sources of magnetic excitation formed by permanent magnets and by induction coils.

1. A rotor of a multipolar synchronous electric machine, comprising:
a plurality of salient poles;
a source of magnetomotive force distributed on each of the salient poles, configured to generate a magnetic flux configured to encompass an armature of a stator, a leakage of the magnetic flux generated by the source of magnetomotive force being dispersed between the salient poles of the rotor; and
a magnetic compensation source configured and dimensioned to compensate at least part of the leakage of the magnetic flux dispersed between the salient poles.

2. The rotor of a multipolar synchronous electric machine according to claim 1, wherein the magnetic compensation source includes a permanent magnet.

3. The rotor of a multipolar synchronous electric machine according to claim 1, wherein each salient pole of the plurality of salient poles includes a pair of pole tips located on either side of the salient pole, the magnetic compensation source being mounted in a detachable manner between two pole tips at a level of an interpolar space.

4. The rotor of a multipolar synchronous electric machine according to claim 1, wherein the pole tips include a groove, a shape of which is adapted to receive, by sliding, the compensation source.

5. The rotor of a multipolar synchronous electric machine according to claim 4, wherein the grooves are continuous along the pole tips.

6. The rotor of a multipolar synchronous electric machine according to claim 5, wherein the shape of the grooves and a complementary shape of the compensation source are adapted to maintain the compensation source radially under the effect of a centrifugal force.

7. The rotor of a multipolar synchronous electric machine according to claim 1, wherein the magnetic compensation source is formed by a compensation block including a permanent magnet, the compensation block being positioned between two salient poles.

8. The rotor of a multipolar synchronous electric machine according to claim 7, wherein the compensation block is formed by two non-magnetic plates arranged on either side of the permanent magnet.

9. The rotor of a multipolar synchronous electric machine according to claim 7, wherein the compensation block includes two shims of mild steel bordering the magnet, a shape of the shims being adapted to cooperate with the grooves of the pole tips.

10. The rotor of a multipolar synchronous electric machine according to claim 1, wherein the magnetic compensation source includes an electromagnet.

11. The rotor of a multipolar synchronous electric machine according to claim 1, wherein the magnetic compensation source includes an induction coil.

12. The rotor of a multipolar synchronous electric machine according to claim 1, wherein the magnetic compensation source includes a duct configured to permit circulation of a cooling fluid.

13. The rotor of a multipolar synchronous electric machine according to claim 1, wherein the source of magnetomotive force is realized by induction coils surrounding each salient pole.

14. The rotor of a multipolar synchronous electric machine according to claim 1, wherein the source of magnetomotive force is realized by permanent magnets.

15. The rotor of a multipolar synchronous electric machine according to claim 1, comprising a first source of magnetomotive force realized by induction coils and a second source of magnetomotive force realized by permanent magnets.

16. A synchronous electric machine including a rotor with salient poles according to claim 1.
